(19) United States
(12) Patent Application Publication
(10) Pub. No.: US 2020/0221049 A1
(43) Pub. Date: Jul. 9, 2020

(54) Method and System for Implementing Over the Top (OTT) Service Implementation Coupled with Over the Air (OTA) Tuning

(71) Applicant: CenturyLink Intellectual Property LLC, Broomfield, CO (US)

(72) Inventor: Jonathan J. Vermes, Onalaska, WI (US)

(21) Appl. No.: 16/387,176

(22) Filed: Apr. 17, 2019

Related U.S. Application Data
(60) Provisional application No. 62/790,088, filed on Jan. 9, 2019.

(51) Int. Cl. H04N 5/445; H04N 21/482; H04N 21/426

(52) U.S. Cl. CPC H04N 5/44543; H04N 2005/44565; H04N 21/42638; H04N 21/482

(57) ABSTRACT

Novel tools and techniques are provided for implementing over the top service implementation coupled with over the air tuning. In various embodiments, an integrated media presentation device might receive one or more over the top (“OTT”) service signals, information associated with each OTT media content received in the one or more OTT service signals, one or more over the air (“OTA”) service signals, location information associated with location of the integrated media presentation device, and information associated with each OTA media content received in the one or more OTA service signals. The integrated media presentation device might compile the received information associated with each OTT media content and the received information associated with each OTA media content, might generate an integrated electronic program guide (“EPG”) that integrates the compiled information; and might display, on a display device, the generated integrated EPG.

### CROSS-REFERENCES TO RELATED APPLICATIONS

This application claims priority to U.S. Patent Application Ser. No. 62/790,088 (the “'088 Application”), filed Jan. 9, 2019 by Jonathan J. Vermes (attorney docket no. 1523-US-P1), entitled, “Method and System for Implementing Over the Top (OTT) Service Implementation Coupled with Over the Air (OTA) Tuning,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing presentation of media content, and, more particularly, to methods, systems, and apparatuses for implementing over the top (“OTT”) service implementation coupled with over the air (“OTA”) tuning.

### BACKGROUND

Some conventional media content provisioning services might provide over the top (“OTT”) or video streaming services that a user can view on his or her display device(s). However, such conventional media content provisioning services typically do not provide over the air (“OTA”) tuning functionality concurrent with the OTT or video streaming services. For conventional media content provisioning services that do provide some combination of OTT and OTA functionality, such services do not typically also provide electronic programming guide (“EPG”) functionality that combines media information for both the OTT and OTA media content, much less allow automatic tuning to OTT or OTA channels in response to user selection of particular OTT or OTA media content listed on the EPG.

Hence, there is a need for more robust and scalable solutions for implementing presentation of media content, and, more particularly, to methods, systems, and apparatuses for implementing over the top (“OTT”) service implementation coupled with over the air (“OTA”) tuning.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing over the top (“OTT”) service implementation coupled with over the air (“OTA”) tuning, in accordance with various embodiments.

FIG. 2 is a schematic diagram illustrating another system for implementing OTT service implementation coupled with OTA tuning, in accordance with various embodiments.

FIG. 3 is a schematic diagram illustrating a system for implementing an electronic program guide that may be used during implementation of OTT service implementation coupled with OTA tuning, in accordance with various embodiments.

FIGS. 4A-4C are flow diagrams illustrating a method for implementing OTT service implementation coupled with OTA tuning, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing presentation of media content, and, more particularly, to methods, systems, and apparatuses for implementing over the top (“OTT”) service implementation coupled with over the air (“OTA”) tuning.

In various embodiments, a media device(s) or integrated media presentation device(s) might receive one or more over the top (“OTT”) service signals; might receive information associated with each OTT media content received in the one or more OTT service signals; might receive one or more OTA service signals; might receive location information associated with location of the integrated media presentation device; and receive information associated with each OTA media content received in the one or more OTA service signals, where the information associated with each OTA media content received in the one or more OTA service signals might be based on the received location information. The media device(s) or integrated media presentation device(s) might compile the received information associated with each OTT media content received in the one or more OTT service signals and the received information associated with each OTA media content received in the one or more OTA service signals; might generate an integrated electronic program guide (“EPG”) that integrates the compiled information associated with each OTT media content received in the one or more OTT service signals and information associated with each OTA media content received in the one or more OTA service signals; and might display, on a display device, the generated integrated EPG that presents the compiled information associated with each OTT media content received in the one or more OTT service signals and information associated with each OTA media content received in the one or more OTA service signals.

In some embodiments, the media device(s) or integrated media presentation device(s) might receive one or more television cable service signals, and might receive information associated with each television cable media content received in the one or more television cable service signals. In such cases, compiling the received information associated with each OTT media content received in the one or more OTT service signals and the received information associated with each OTA media content received in the one or more OTA service signals might comprise compiling, with the integrated media presentation device, the received information associated with each OTT media content received in the one or more OTT service signals, the received information associated with each OTA media content received in the one or more OTA service signals, and the received information associated with each television cable media content received in the one or more television cable service signals. Generating the integrated electronic program guide (“EPG”) that integrates the compiled information associated with each OTT media content received in the one or more OTT service signals and information associated with each OTA media content received in the one or more OTA service signals might comprise generating, with the integrated media presentation device, an integrated EPG that integrates the compiled information associated with each OTT media content received in the one or more OTT service signals, information associated with each OTA media content received in the one or more OTA service signals, and information associated with each television cable media content received in the one or more television cable service signals. Displaying the generated integrated EPG that presents the compiled information associated with each OTT media content received in the one or more OTT service signals and information associated with each OTA media content received in the one or more OTA service signals might comprise displaying, with the integrated media presentation device and on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals.

In some aspects, selection by the user of a streaming channel, an OTA channel, or a third party channel might cause the integrated media presentation device(s) to automatically select the input source (regardless of streaming source, OTA signal source, or third party media source, or the like) on the integrated media presentation device(s) for display of the selected channel on the display device. For example, in response to receiving a user selection of a particular channel number, a particular named channel, or a particular media content, or the like as displayed on the generated integrated EPG, the media device(s) or integrated media presentation device(s) might automatically tune a signal receiver of the media device(s) or integrated media presentation device(s) to select the input source corresponding to the user selection, might display, on the display device, video content associated with the selected channel number, named channel, or media content, and might present, on one or more audio playback devices, audio content (or audio signals in video content, or the like) associated with the selected channel number, named channel, or media content, the video content and the audio content being received in the OTT service signals and/or the OTA service signals (and/or the one or more television cable service signals, or the like).

These and other aspects of the over the top (“OTT”) service implementation coupled with over the air (“OTA”) tuning are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, media content streaming or downloading technology, media content navigation or selection technology, user interface technology, electronic program guide technology, and/or the like. In other aspects, certain embodiments, can improve the functioning of user equipment or systems themselves (e.g., media players, set-top boxes (“STBs”), media content streaming or downloading systems, electronic program guide systems, etc.), for example, by receiving, with an integrated media presentation device, one or more over the top (“OTT”) service signals; receiving, with the integrated media presentation device, information associated with each OTT media content received in the one or more OTT service signals; receiving, with the integrated media presentation device, one or more over the air (“OTA”) service signals; receiving, with the integrated media presentation device, location information associated with location of the integrated media presentation device; receiving, with the integrated media presentation device, information associated with each OTA media content received in the one or more OTA service signals, wherein the information associated with each OTA media content received in the one or more OTA service signals is based on the received location information; compiling, with the integrated media presentation device, the received information associated with each OTT media content received in the one or more OTT service signals and the received information associated with each OTA media content received in the one or more OTA service signals; generating, with the integrated media presentation device, an integrated electronic program guide (“EPG”) that integrates the compiled information associated with each OTT media content received in the one or more OTT service signals and information associated with each OTA media content received in the one or more OTA service signals; and displaying, with the integrated media presentation device and on a display device, the generated integrated EPG that presents the compiled information associated with each OTT media content received in the one or more OTT service signals and information associated with each OTA media content received in the one or more OTA service signals; and/or the like.

In particular, to the extent any abstract concepts are present in the various embodiments, those concepts can be implemented as described herein by devices, software, systems, and methods that involve specific novel functionality (e.g., steps or operations), such as, in response to receiving a user selection of a particular channel number, a particular named channel, or a particular media content, or the like as displayed on the generated integrated EPG, automatically tuning, with the media device(s) or integrated media presentation device(s), a signal receiver of the media device(s) or integrated media presentation device(s) to select the input source corresponding to the user selection; displaying, on the display device, video content associated with the selected channel number, named channel, or media content; and presenting, on one or more audio playback devices, audio content (or audio signals in video content, or the like) associated with the selected channel number, named channel, or media content, the video content and the audio content being received in the OTT service signals and/or the OTA service signals (and/or the one or more television cable service signals, or the like); and/or the like, which optimizes presentation and navigation of the media content (particularly video content) thus providing for smoother and more efficient navigation and selection by the user of video content from a combination of OTT and OTA sources, and/or the like, to name a few examples, that extend beyond mere conventional computer processing operations. These functionalities can produce tangible results outside of the implementing computer system, including, merely by way of example, optimized presentation, navigation, and selection by the user of media content (including video content) from a combination of OTT and OTA sources, and/or the like, at least some of which may be observed or measured by customers and/or service providers.

In an aspect, a method might comprise receiving, with an integrated media presentation device, one or more over the top (“OTT”) service signals; receiving, with the integrated media presentation device, information associated with each OTT media content received in the one or more OTT service signals; receiving, with the integrated media presentation device, one or more over the air (“OTA”) service signals; receiving, with the integrated media presentation device, location information associated with location of the integrated media presentation device; and receiving, with the integrated media presentation device, information associated with each OTA media content received in the one or more OTA service signals, wherein the information associated with each OTA media content received in the one or more OTA service signals is based on the received location information. The method might further comprise compiling, with the integrated media presentation device, the received information associated with each OTT media content received in the one or more OTT service signals and the received information associated with each OTA media content received in the one or more OTA service signals; generating, with the integrated media presentation device, an integrated electronic program guide (“EPG”) that integrates the compiled information associated with each OTT media content received in the one or more OTT service signals and information associated with each OTA media content received in the one or more OTA service signals; and displaying, with the integrated media presentation device and on a display device, the generated integrated EPG that presents the compiled information associated with each OTT media content received in the one or more OTT service signals and information associated with each OTA media content received in the one or more OTA service signals.

In some embodiments, the integrated media presentation device might comprise at least one of a set-top box (“STB”), a digital video recording and playback device (“DVR”), a universal serial bus (“USB”)-based streaming device, a cable television tuner, an OTT tuner, or an OTA tuner, and/or the like. In some cases, the integrated media presentation device might comprise a master device and one or more slave devices that service two or more display devices in a customer premises associated with a user. In some instances, the master device might comprise an OTA tuner, while the one or more slave devices might not comprise any OTA tuners. Alternatively, at least one slave device might each also comprise an OTA tuner. According to some embodiments, the location information associated with the location of the integrated media presentation device might comprise at least one of local area code, local zip code, billing address of a user associated with the integrated media presentation device, service address of the user associated with the integrated media presentation device, or location data obtained for identifying location of the integrated media presentation device, and/or the like.

Merely by way of example, in some cases, the method might comprise, in response to one or more first user commands received from a user indicating to record at least one first OTA media content among the received OTA media content received in the one or more OTA service signals, storing, with the integrated media presentation device and on a local datastore, the at least one first OTA media content, wherein storing the at least one first OTA media content on the local datastore might be performed in a similar manner as storing of OTT media content on the local datastore. In such cases, the method might further comprise, in response to one or more second user commands received from the user indicating to stream at least one second OTA media content among the at least one first OTA media content, sending, with the integrated media presentation device and to a mobile user device associated with the user, the at least one second OTA media content for streaming of the at least one second OTA media content on the mobile user device.

In some embodiments, the method might further comprise, in response to one or more third user commands received from a user indicating to stream at least one third OTA media content among the received OTA media content received in the one or more OTA service signals, sending, with the integrated media presentation device and to a mobile user device associated with the user, the at least one third OTA media content for streaming of the at least one third OTA media content on the mobile user device.

According to some embodiments, the method might further comprise receiving, with the integrated media presentation device, one or more television cable service signals; and receiving, with the integrated media presentation device, information associated with each television cable media content received in the one or more television cable service signals. In such cases, compiling the received information associated with each OTT media content received in the one or more OTT service signals and the received information associated with each OTA media content received in the one or more OTA service signals might comprise compiling, with the integrated media presentation device, the received information associated with each OTT media content received in the one or more OTT service signals, the received information associated with each OTA media content received in the one or more OTA service signals, and the received information associated with each television cable media content received in the one or more television cable service signals. Generating the integrated EPG that integrates the compiled information associated with each OTT media content received in the one or more OTT service signals and information associated with each OTA media content received in the one or more OTA service signals might comprise generating, with the integrated media presentation device, an integrated EPG that integrates the compiled information associated with each OTT media content received in the one or more OTT service signals, information associated with each OTA media content received in the one or more OTA service signals, and information associated with each television cable media content received in the one or more television cable service signals. Displaying the generated integrated EPG that presents the compiled information associated with each OTT media content received in the one or more OTT service signals and information associated with each OTA media content received in the one or more OTA service signals might comprise displaying, with the integrated media presentation device and on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals.

In some embodiments, the method might further comprise receiving, with the integrated media presentation device, one or more fourth user commands from a user indicating to customize at least one of display format of the integrated EPG, channels of media content to display in the integrated EPG, or types of media content to display in the integrated EPG. In such cases, generating the integrated EPG might comprise generating, with the integrated media presentation device, an integrated EPG, based on the received one or more fourth user commands, wherein the display format might comprise at least one of format, orientation, or order of one or more categories, and/or the like, wherein the one or more categories might comprise at least one of channel numbers, channel designations, or broadcast times, and/or the like.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive one or more over the top (“OTT”) service signals; receive information associated with each OTT media content received in the one or more OTT service signals; receive one or more over the air (“OTA”) service signals; receive location information associated with location of the integrated media presentation device; receive information associated with each OTA media content received in the one or more OTA service signals, wherein the information associated with each OTA media content received in the one or more OTA service signals is based on the received location information; compile the received information associated with each OTT media content received in the one or more OTT service signals and the received information associated with each OTA media content received in the one or more OTA service signals; generate an integrated electronic program guide (“EPG”) that integrates the compiled information associated with each OTT media content received in the one or more OTT service signals and information associated with each OTA media content received in the one or more OTA service signals; and display, on a display device, the generated integrated EPG that presents the compiled information associated with each OTT media content received in the one or more OTT service signals and information associated with each OTA media content received in the one or more OTA service signals.

In some embodiments, the apparatus might comprise at least one of a set-top box (“STB”), a digital video recording and playback device (“DVR”), a universal serial bus (“USB”)-based streaming device, a cable television tuner, an OTT tuner, or an OTA tuner, and/or the like. In some cases, the apparatus might comprise a master device and one or more slave devices that service two or more display devices in a customer premises associated with a user. In some instances, the master device might comprise an OTA tuner, while the one or more slave devices might not comprise any OTA tuners. Alternatively, at least one slave device might each also comprise an OTA tuner.

According to some embodiments, the set of instructions, when executed by the at least one processor, might further cause the apparatus to: in response to one or more first user commands received from a user indicating to record at least one first OTA media content among the received OTA media content received in the one or more OTA service signals, storing, with the apparatus and on a local datastore, the at least one first OTA media content, wherein storing the at least one first OTA media content on the local datastore is performed in a similar manner as storing of OTT media content on the local datastore. In such cases, the set of instructions, when executed by the at least one processor, might further cause the apparatus to: in response to one or more second user commands received from the user indicating to stream at least one second OTA media content among the at least one first OTA media content, sending, with the apparatus and to a mobile user device associated with the user, the at least one second OTA media content for streaming of the at least one second OTA media content on the mobile user device.

In some embodiments, the set of instructions, when executed by the at least one processor, might further cause the apparatus to: in response to one or more third user commands received from a user indicating to stream at least one third OTA media content among the received OTA media content received in the one or more OTA service signals, sending, with the apparatus and to a mobile user device associated with the user, the at least one third OTA media content for streaming of the at least one third OTA media content on the mobile user device.

According to some embodiments, the set of instructions, when executed by the at least one processor, might further cause the apparatus to: receive one or more television cable service signals; and receive information associated with each television cable media content received in the one or more television cable service signals. In such cases, compiling the received information associated with each OTT media content received in the one or more OTT service signals and the received information associated with each OTA media content received in the one or more OTA service signals might comprise compiling the received information associated with each OTT media content received in the one or more OTT service signals, the received information associated with each OTA media content received in the one or more OTA service signals, and the received information associated with each television cable media content received in the one or more television cable service signals. Generating the integrated EPG that integrates the compiled information associated with each OTT media content received in the one or more OTT service signals and information associated with each OTA media content received in the one or more OTA service signals might comprise generating an integrated EPG that integrates the compiled information associated with each OTT media content received in the one or more OTT service signals, information associated with each OTA media content received in the one or more OTA service signals, and information associated with each television cable media content received in the one or more television cable service signals. Displaying the generated integrated EPG that presents the compiled information associated with each OTT media content received in the one or more OTT service signals and information associated with each OTA media content received in the one or more OTA service signals might comprise displaying, on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals.

In some embodiments, the set of instructions, when executed by the at least one processor, might further cause the apparatus to: receive one or more fourth user commands from a user indicating to customize at least one of display format of the integrated EPG, channels of media content to display in the integrated EPG, or types of media content to display in the integrated EPG. In such cases, generating the integrated EPG might comprise generating an integrated EPG, based on the received one or more fourth user commands, wherein the display format might comprise at least one of format, orientation, or order of one or more categories, and/or the like, wherein the one or more categories comprises at least one of channel numbers, channel designations, or broadcast times, and/or the like.

In yet another aspect, a system might comprise an integrated media presentation device, which might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the integrated media presentation device to: receive one or more over the top (“OTT”) service signals; receive information associated with each OTT media content received in the one or more OTT service signals; receive one or more over the air (“OTA”) service signals; receive location information associated with location of the integrated media presentation device; receive information associated with each OTA media content received in the one or more OTA service signals, wherein the information associated with each OTA media content received in the one or more OTA service signals is based on the received location information; compile the received information associated with each OTT media content received in the one or more OTT service signals and the received information associated with each OTA media content received in the one or more OTA service signals; generate an integrated electronic program guide (“EPG”) that integrates the compiled information associated with each OTT media content received in the one or more OTT service signals and information associated with each OTA media content received in the one or more OTA service signals; and display, on a display device, the generated integrated EPG that presents the compiled information associated with each OTT media content received in the one or more OTT service signals and information associated with each OTA media content received in the one or more OTA service signals.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

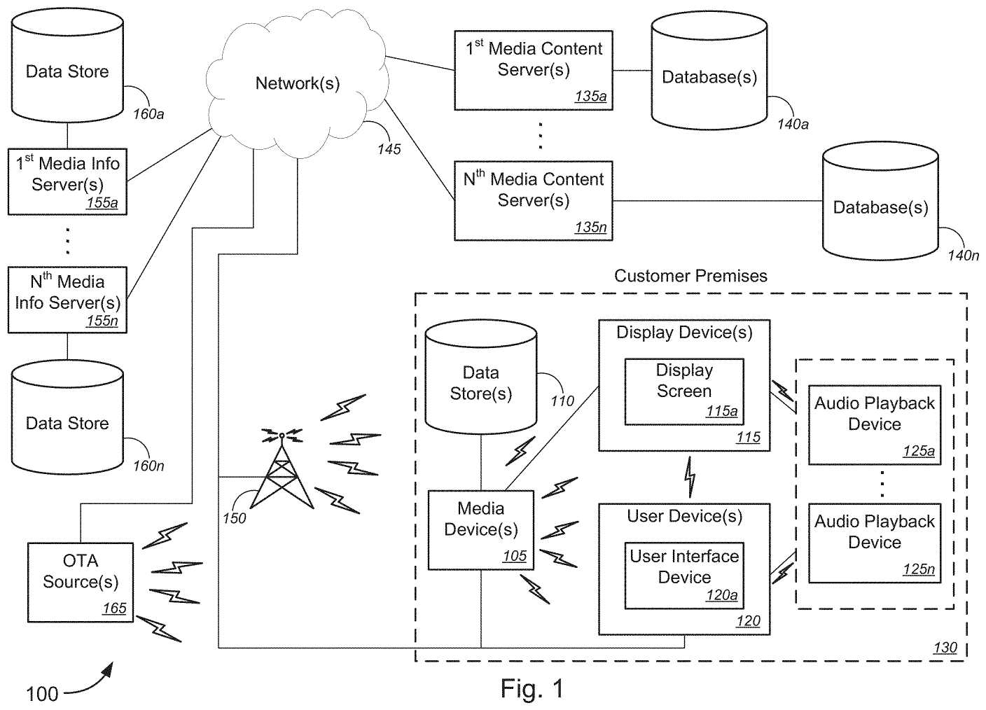

We now turn to the embodiments as illustrated by the drawings. FIGS. 1-6 illustrate some of the features of the method, system, and apparatus for implementing presentation of media content, and, more particularly, to methods, systems, and apparatuses for implementing over the top (“OTT”) service implementation coupled with over the air (“OTA”) tuning, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

FIG. 1 is a schematic diagram illustrating a system 100 for implementing over the top (“OTT”) service implementation coupled with over the air (“OTA”) tuning, in accordance with various embodiments.

In the non-limiting embodiment of FIG. 1, system 100 might comprise a media device(s) or integrated media presentation device(s) 105 and a data store or database 110 that is local to the media device(s) or integrated media presentation device(s) 105. In some cases, the database 110 might be external, yet communicatively coupled, to the media device(s) or integrated media presentation device(s) 105. In other cases, the database 110 might be integrated within the media device(s) or integrated media presentation device(s) 105. System 100, according to some embodiments, might further comprise one or more display devices 115 (collectively, “display devices 115” or the like), which might each include a display screen 115a, and one or more user devices 120 (collectively, “user devices 120” or the like), which might each include a touchscreen display device or other user interface device 120a, and/or the like. In some cases, system 100 might further, or optionally, comprise one or more audio playback devices 125a-125n (collectively, “audio playback devices 125” or “speakers 125” or the like), and/or the like. Each of the one or more display devices 115 and/or the one or more user devices 120 might communicatively couple to the media device(s) or integrated media presentation device(s) 105, and/or to each other, either via wireless connection and/or via wired connection. The one or more user devices 120 might each receive user input from a user (in various embodiments, receiving touch input from the user via the user interface device 120a), and might each relay the user input to the media device(s) or integrated media presentation device(s) 105, according to some embodiments. In some cases, the user devices 120 might include, without limitation, at least one of a dedicated remote control device (with touchscreen display) that is associated with the media device(s) or integrated media presentation device(s) 105, a universal remote control device (with touchscreen display) that has been paired, synced, or synchronized with the media device(s) or integrated media presentation device(s) 105, a tablet computer that has been paired, synced, or synchronized with the media device(s) or integrated media presentation device(s) 105, a smart phone that has been paired, synced, or synchronized with the media device(s) or integrated media presentation device(s) 105, or other portable device (with touchscreen display) that has been paired, synced, or synchronized with the media device(s) or integrated media presentation device(s) 105, and/or the like. In some cases, the media device(s) or integrated media presentation device(s) 105, the database 110, the one or more display devices 115 (including the display screen(s) 115a and/or the audio playback device(s) 125, etc.), and the user device(s) 120 may be disposed within a customer premises 130, which might be one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, and/or the like.

In some embodiments, the media device(s) or integrated media presentation device(s) 105 might comprise one of a processor on the display device running a software application (“app”), a processor on the user device running an app, a media player, and/or the like. In some cases, the media device(s) or integrated media presentation device(s) 105 might include, but is not limited to, one of a set-top box (“STB”), a media player, a gaming console, a server computer, a desktop computer, a laptop computer, a universal serial bus (“USB”)-based streaming device, a cable television tuner, an OTT tuner, or an OTA tuner, and/or the like. The media player might include, without limitation, one of a digital versatile disc or digital video disc (“DVD”) player, a Blu-ray disc (“BD”) player, a digital video recording (“DVR”) device, a streaming video player, a streaming music player, or a streaming game player, and/or the like, while the one or more display devices 115 might include, but are not limited to, at least one of one or more monitors (e.g., computer monitor or laptop monitor, or the like), one or more television sets (e.g., smart television sets or other television sets, or the like), and/or the like. In some cases, the user device 120 might include, without limitation, one of a laptop computer, a tablet computer, a smart phone, a mobile phone, a personal digital assistant, a remote control device, or a portable gaming device, and/or the like. According to some embodiments, the media device(s) or integrated media presentation device(s) 105 might comprise a master device and one or more slave devices that service two or more display devices 115 in the customer premises 130 associated with a user. In some cases, the master device might comprise an over the air (“OTA”) tuner, while the one or more slave devices do not comprise any OTA tuners. Alternatively, at least one slave device might each also comprise an OTA tuner.

System 100 might further comprise one or more media content sources or servers 135a-135n (collectively, “media content sources or servers 135” or the like) and corresponding databases 140a-140n (collectively, “databases 140” or the like) that might communicatively couple to the media device(s) or integrated media presentation device(s) 105 via one or more networks 145 (and in some cases, via one or more telecommunications relay systems 150, which might include, without limitation, one or more wireless network interfaces (e.g., wireless modems, wireless access points, and the like), one or more towers, one or more satellites, and/or the like). The lightning bolt symbols are used to denote wireless communications between the one or more telecommunications relay systems 150 and the media device(s) or integrated media presentation device(s) 105, between the one or more telecommunications relay systems 150 and each of at least one of the user devices 120, between the media device(s) or integrated media presentation device(s) 105 and each of at least one of the display devices 115, between the media device(s) or integrated media presentation device(s) 105 and each of at least one of the user devices 120, between the display device 115 and the user devices 120, between the media device(s) or integrated media presentation device(s) 105 and each of the one or more audio playback devices 125a-125n, between the display device 115 and each of at least one of the one or more audio playback devices 125a-125n, between the user devices 120 and each of at least one of the one or more audio playback devices 125a-125n, and/or the like.

In some embodiments, system 100 might further comprise one or more media information sources or servers 155a-155n (collectively, “media information sources or servers 155” or the like) and corresponding databases 160a-160n (collectively, “databases 160” or the like) that might communicatively couple to the media device(s) or integrated media presentation device(s) 105 via one or more networks 145 (and in some cases, via one or more telecommunications relay systems 150). According to some embodiments, system 100 might further comprise OTA sources 165, which might transmit OTA signals to one or more antennas of the media device(s) or integrated media presentation device(s) 105 via radio frequency waves or the like.

In operation, the media device(s) or integrated media presentation device(s) 105 might receive one or more over the top (“OTT”) service signals; might receive information associated with each OTT media content received in the one or more OTT service signals; might receive one or more OTA service signals (e.g., from OTA source(s) 165 or the like); might receive location information associated with location of the integrated media presentation device; and receive information associated with each OTA media content received in the one or more OTA service signals, where the information associated with each OTA media content received in the one or more OTA service signals might be based on the received location information. The media device(s) or integrated media presentation device(s) 105 might compile the received information associated with each OTT media content received in the one or more OTT service signals and the received information associated with each OTA media content received in the one or more OTA service signals; might generate an integrated electronic program guide (“EPG”) that integrates the compiled information associated with each OTT media content received in the one or more OTT service signals and information associated with each OTA media content received in the one or more OTA service signals; and might display, on a display device (e.g., display device(s) 115 or the like), the generated integrated EPG that presents the compiled information associated with each OTT media content received in the one or more OTT service signals and information associated with each OTA media content received in the one or more OTA service signals.

In some embodiments, the location information associated with the location of the integrated media presentation device might include, without limitation, at least one of local area code, local zip code, billing address of a user associated with the integrated media presentation device, service address of the user associated with the integrated media presentation device, or location data obtained for identifying location of the integrated media presentation device, and/or the like.

According to some embodiments, in response to one or more first user commands received from a user indicating to record at least one first OTA media content among the received OTA media content received in the one or more OTA service signals, the media device(s) or integrated media presentation device(s) 105 might store, on a local datastore (e.g., datastore(s) 110, or the like), the at least one first OTA media content, where storing the at least one first OTA media content on the local datastore might be performed in a similar manner as storing of OTT media content on the local datastore. In response to one or more second user commands received from the user indicating to stream at least one second OTA media content among the at least one first OTA media content, the media device(s) or integrated media presentation device(s) 105 might send, to a mobile user device associated with the user (e.g., user device 120), the at least one second OTA media content for streaming of the at least one second OTA media content on the mobile user device.

Alternatively, or additionally, in response to one or more third user commands received from a user (whether the same user as referred to above or a different user) indicating to stream at least one third OTA media content among the received OTA media content received in the one or more OTA service signals, the media device(s) or integrated media presentation device(s) 105 might send, to a mobile user device associated with the user (e.g., user device 120), the at least one third OTA media content for streaming of the at least one third OTA media content on the mobile user device.

Alternatively, or additionally, the media device(s) or integrated media presentation device(s) 105 might receive one or more fourth user commands from a user (whether the same user as referred to above or a different user) indicating to customize at least one of display format of the integrated EPG, channels of media content to display in the integrated EPG, or types of media content to display in the integrated EPG, and/or the like. In such cases, generating the integrated EPG might comprise generating, with the integrated media presentation device, an integrated EPG, based on the received one or more fourth user commands, where the display format might include, without limitation, at least one of format, orientation, and order of one or more categories, and/or the like, where the one or more categories might include, but is not limited to, at least one of channel numbers, channel designations, or broadcast times, and/or the like.

In some embodiments, the media device(s) or integrated media presentation device(s) 105 might receive one or more television cable service signals, and might receive information associated with each television cable media content received in the one or more television cable service signals. In such cases, compiling the received information associated with each OTT media content received in the one or more OTT service signals and the received information associated with each OTA media content received in the one or more OTA service signals might comprise compiling, with the integrated media presentation device, the received information associated with each OTT media content received in the one or more OTT service signals, the received information associated with each OTA media content received in the one or more OTA service signals, and the received information associated with each television cable media content received in the one or more television cable service signals. Generating the integrated electronic program guide (“EPG”) that integrates the compiled information associated with each OTT media content received in the one or more OTT service signals and information associated with each OTA media content received in the one or more OTA service signals might comprise generating, with the integrated media presentation device, an integrated EPG that integrates the compiled information associated with each OTT media content received in the one or more OTT service signals, information associated with each OTA media content received in the one or more OTA service signals, and information associated with each television cable media content received in the one or more television cable service signals. Displaying the generated integrated EPG that presents the compiled information associated with each OTT media content received in the one or more OTT service signals and information associated with each OTA media content received in the one or more OTA service signals might comprise displaying, with the integrated media presentation device and on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals.

In some aspects, selection by the user of a streaming channel, an OTA channel, or a third party channel might cause the integrated media presentation device(s) 105 to automatically select the input source (regardless of streaming source, OTA signal source, or third party media source, or the like) on the integrated media presentation device(s) 105 for display of the selected channel on the display device. For example, in response to receiving a user selection of a particular channel number, a particular named channel, or a particular media content, or the like as displayed on the generated integrated EPG, the media device(s) or integrated media presentation device(s) 105 might automatically tune a signal receiver of the media device(s) or integrated media presentation device(s) 105 to select the input source corresponding to the user selection, might display, on the display device (e.g., display device(s) 115, or the like), video content associated with the selected channel number, named channel, or media content, and might present, on one or more audio playback devices (e.g., audio playback device(s) 125, or the like), audio content (or audio signals in video content, or the like) associated with the selected channel number, named channel, or media content, the video content and the audio content being received in the OTT service signals and/or the OTA service signals (and/or the one or more television cable service signals, or the like).

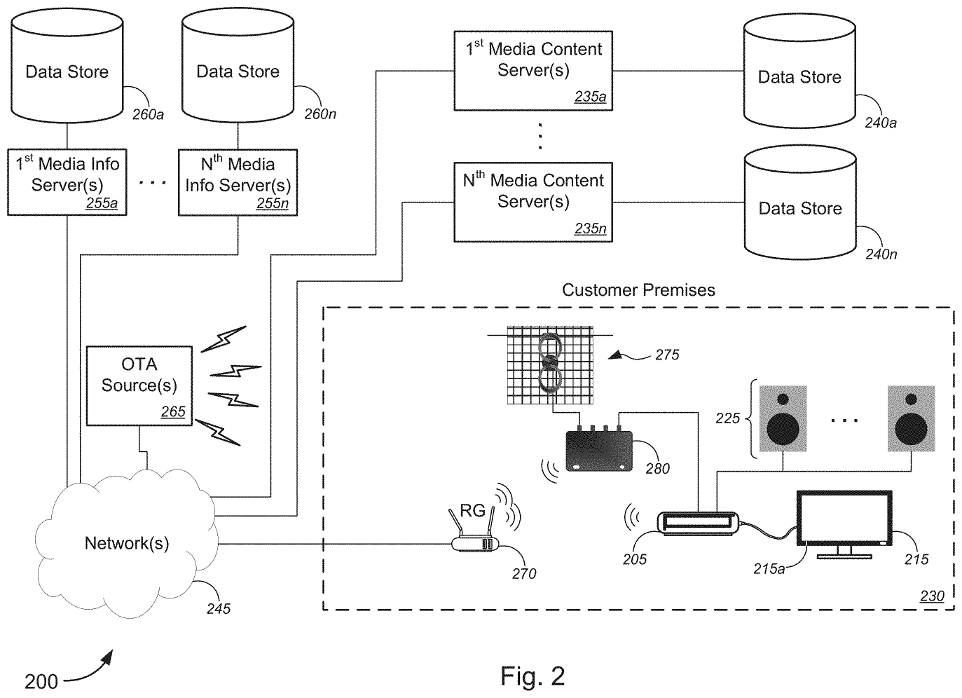

These and other functions of the system 100 (and its components) are described in greater detail below with respect to FIGS. 2-4.

FIG. 2 is a schematic diagram illustrating another system 200 for implementing OTT service implementation coupled with OTA tuning, in accordance with various embodiments.

In the non-limiting embodiment of FIG. 2, system 200 might comprise a media device(s) or integrated media presentation device(s) 205 and a display device 215 with display screen 215a. In some embodiments, as shown in FIG. 2, the media device(s) or integrated media presentation device(s) 205 might comprise a set-top box (“STB”). Although not shown, the media device(s) or integrated media presentation device(s) 205 might alternatively comprise one of a processor on the display device running a software application (“app”), a processor on the user device running an app, a media player, and/or the like. In some cases, the media device(s) or integrated media presentation device(s) 205 might alternatively include, but is not limited to, one of a media player, a gaming console, a server computer, a desktop computer, a laptop computer, a universal serial bus (“USB”)-based streaming device, a cable television tuner, an OTT tuner, or an OTA tuner, and/or the like. The media player might include, without limitation, one of a digital versatile disc or digital video disc (“DVD”) player, a Blu-ray disc (“BD”) player, a digital video recording (“DVR”) device, a streaming video player, a streaming music player, or a streaming game player, and/or the like, while the one or more display devices 215 might include, but are not limited to, at least one of one or more monitors (e.g., computer monitor or laptop monitor, or the like), one or more television sets (e.g., smart television sets or other television sets, or the like), and/or the like. Each of the one or more display devices 215 might communicatively couple to the media device(s) or integrated media presentation device(s) 205, and/or to each other, either via wireless connection and/or via wired connection.

System 200, according to some embodiments, might further comprise one or more audio playback devices 225 (collectively, “audio playback devices 225” or “speakers 225” or the like), a residential gateway (“RG”) or RG device 270, an antenna 275, and an OTA, satellite, or cable TV receiver 280, all of which might be disposed at customer premises 230. In some cases, the customer premises 230 might be one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, and/or the like.

In some embodiments, the antenna 275 might include, but is not limited to, a passive antenna intended to be connected to the STB's antenna input (which, in North America, is typically an F-connector, or the like), a passive antenna with amplifier to boost the signal (which might also be intended to be connected to a STB's antenna input), or an antenna with an amplifier, demodulating circuitry, and network interfaces, intended for distribution of the OTA signal throughout a building via a wired or wireless network (this enables devices without a tuner to receive OTA signals, or the like), and/or the like. In the non-limiting example of FIG. 2, the OTA, satellite, or cable TV receiver 280 might receive OTA signals picked up by the antenna 275, might amplify and demodulate the received OTA signals, and/or might, in some cases, communicatively couple (either via direct wireless connection or via wired connection) with STB 205 to allow the STB 205 to access the OTA video stream and be capable of displaying it on display device 215. Alternatively, or additionally, the OTA, satellite, or cable TV receiver 280 might communicatively couple (wirelessly) with RG 270, which might communicatively couple with, and enable, all devices (i.e., the STB 205, the display device 215, the user devices 220 (not shown in FIG. 2), or the like) on the home network (whether wireless or wired) to access the OTA video stream and be capable of displaying it via a suitable video player (e.g., hardware and/or software).

System 200 might further comprise one or more first media content sources or servers 235a through one or more N^{th} media content sources or servers 235n (collectively, “media content sources 235,” “video content servers 235,” or the like) and corresponding databases 240a-240n (collectively, “databases 240” or the like) that might communicatively couple to the RG 270 via one or more networks 245. The wave symbols are used to denote wireless communications between the RG 270 and the STB 205, between the RG 270 and the OTA, satellite, or cable TV receiver 280, and/or the like. In some embodiments, system 200 might further comprise one or more first media information sources or servers 255a through one or more N^{th} media information sources or servers 255n (collectively, “media information sources 255,” “video information servers 255,” or the like) and corresponding data stores 260a-260n (collectively, “data stores 260” or the like) that might communicatively couple to the RG 270 via the one or more networks 245. The media information sources 255 and corresponding data stores 260 provide the STB 205 with access to media information corresponding to media content that is available from the media content sources 235 and corresponding databases 240. In some cases, the plurality of media content sources 235 might include, but is not limited to, at least two of one or more media streaming sources, one or more media broadcast sources, one or more video streaming sources, one or more video broadcast sources, one or more satellite television (“TV”) sources, one or more cable TV sources, or one or more third party media content sources, and/or the like. According to some embodiments, system 200 might further comprise OTA sources 265, which might transmit OTA signals to one or more antennas of the media device(s) or integrated media presentation device(s) 205 via radio frequency waves (depicted by lightning bolt symbols in FIG. 2), or the like.

According to some embodiments, the media device(s) or integrated media presentation device(s) 205 and the OTA, satellite, or cable TV receiver 280 might comprise a master device and one or more slave devices that service one or more display devices 215 in the customer premises 230 associated with a user. In some cases, the master device might comprise an OTA tuner, while the one or more slave devices do not comprise any OTA tuners. Alternatively, at least one slave device might each also comprise an OTA tuner.

In operation, the STB 205 and/or the OTA, satellite, or cable TV receiver 280 (collectively, “the integrated media presentation device(s)” or the like) might receive one or more over the top (“OTT”) service signals; might receive information associated with each OTT media content received in the one or more OTT service signals; might receive one or more over the air (“OTA”) service signals; might receive location information associated with location of the integrated media presentation device; and receive information associated with each OTA media content received in the one or more OTA service signals, where the information associated with each OTA media content received in the one or more OTA service signals might be based on the received location information. The integrated media presentation device(s) might compile the received information associated with each OTT media content received in the one or more OTT service signals and the received information associated with each OTA media content received in the one or more OTA service signals; might generate an integrated electronic program guide (“EPG”) that integrates the compiled information associated with each OTT media content received in the one or more OTT service signals and information associated with each OTA media content received in the one or more OTA service signals; and might display, on a display device, the generated integrated EPG that presents the compiled information associated with each OTT media content received in the one or more OTT service signals and information associated with each OTA media content received in the one or more OTA service signals.

In some embodiments, the location information associated with the location of the integrated media presentation device might include, without limitation, at least one of local area code, local zip code, billing address of a user associated with the integrated media presentation device, service address of the user associated with the integrated media presentation device, or location data obtained for identifying location of the integrated media presentation device, and/or the like.

According to some embodiments, in response to one or more first user commands received from a user indicating to record at least one first OTA media content among the received OTA media content received in the one or more OTA service signals, the integrated media presentation device(s) might store, on a local datastore, the at least one first OTA media content, where storing the at least one first OTA media content on the local datastore might be performed in a similar manner as storing of OTT media content on the local datastore. In response to one or more second user commands received from the user indicating to stream at least one second OTA media content among the at least one first OTA media content, the integrated media presentation device(s) might send, to a mobile user device associated with the user, the at least one second OTA media content for streaming of the at least one second OTA media content on the mobile user device.

Alternatively, or additionally, in response to one or more third user commands received from a user (whether the same user as referred to above or a different user) indicating to stream at least one third OTA media content among the received OTA media content received in the one or more OTA service signals, the integrated media presentation device(s) might send, to a mobile user device associated with the user, the at least one third OTA media content for streaming of the at least one third OTA media content on the mobile user device.

Alternatively, or additionally, the integrated media presentation device(s) might receive one or more fourth user commands from a user (whether the same user as referred to above or a different user) indicating to customize at least one of display format of the integrated EPG, channels of media content to display in the integrated EPG, or types of media content to display in the integrated EPG, and/or the like. In such cases, generating the integrated EPG might comprise generating, with the integrated media presentation device, an integrated EPG, based on the received one or more fourth user commands, where the display format might include, without limitation, at least one of format, orientation, and order of one or more categories, and/or the like, where the one or more categories might include, but is not limited to, at least one of channel numbers, channel designations, or broadcast times, and/or the like.

In some embodiments, the integrated media presentation device(s) might receive one or more television cable service signals, and might receive information associated with each television cable media content received in the one or more television cable service signals. In such cases, compiling the received information associated with each OTT media content received in the one or more OTT service signals and the received information associated with each OTA media content received in the one or more OTA service signals might comprise compiling, with the integrated media presentation device, the received information associated with each OTT media content received in the one or more OTT service signals, the received information associated with each OTA media content received in the one or more OTA service signals, and the received information associated with each television cable media content received in the one or more television cable service signals. Generating the integrated electronic program guide (“EPG”) that integrates the compiled information associated with each OTT media content received in the one or more OTT service signals and information associated with each OTA media content received in the one or more OTA service signals might comprise generating, with the integrated media presentation device, an integrated EPG that integrates the compiled information associated with each OTT media content received in the one or more OTT service signals, information associated with each OTA media content received in the one or more OTA service signals, and information associated with each television cable media content received in the one or more television cable service signals. Displaying the generated integrated EPG that presents the compiled information associated with each OTT media content received in the one or more OTT service signals and information associated with each OTA media content received in the one or more OTA service signals might comprise displaying, with the integrated media presentation device and on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals.

In some aspects, selection by the user of a streaming channel, an OTA channel, or a third party channel might cause the integrated media presentation device(s) 205 and/or 280 to automatically select the input source (regardless of streaming source, OTA signal source, or third party media source, or the like) on the integrated media presentation device(s) 205 and/or 280 for display of the selected channel on the display device. For example, in response to receiving a user selection of a particular channel number, a particular named channel, or a particular media content, or the like as displayed on the generated integrated EPG, the media device(s) or integrated media presentation device(s) 205 and/or 280 might automatically tune a signal receiver of the media device(s) or integrated media presentation device(s) 205 and/or 280 to select the input source corresponding to the user selection, might display, on the display device (e.g., display device(s) 215, or the like), video content associated with the selected channel number, named channel, or media content, and might present, on one or more audio playback devices (e.g., audio playback device(s) 225, or the like), audio content (or audio signals in video content, or the like) associated with the selected channel number, named channel, or media content, the video content and the audio content being received in the OTT service signals and/or the OTA service signals (and/or the one or more television cable service signals, or the like).

The STB 205 (or the OTA, satellite, or cable TV receiver 280), the display device 215, the one or more media content sources 235a-235n, the data store 240a-240n, the network(s) 245, the one or more media information sources 255a-255n, the data store 260a-260n, and OTA source(s) 265 of system 200 in FIG. 2 might otherwise be similar, if not identical, to the media device(s) or integrated media presentation device(s) 105, the display device(s) 115, the one or more media content sources 135a-135n, the data store 140a-140n, the network(s) 145, the one or more media information sources 155a-155n, the data store 160a-160n, and OTA source(s) 165, respectively, of system 100 in FIG. 1, and the descriptions of these components of system 100 are applicable to the corresponding components of system 200, respectively.

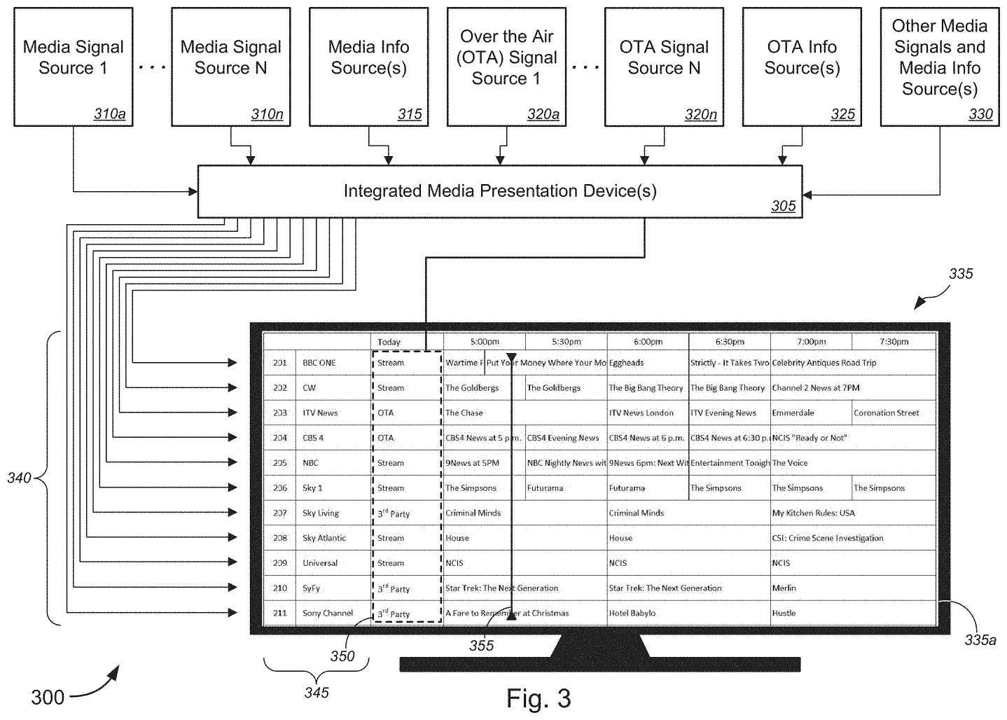

FIG. 3 is a schematic diagram illustrating a system 300 for implementing an electronic program guide that may be used during implementation of OTT service implementation coupled with OTA tuning, in accordance with various embodiments.

In the non-limiting embodiment of FIG. 3, system 300 might comprise integrated media presentation device(s) 305, one or more media signal sources 1 through N 310a-310n (collectively, “media signal sources 310,” “video signal sources 310,” or the like), one or more media information sources 315 corresponding to the media content received from the one or more media signal sources 310, one or more over the air (“OTA”) signal sources 1 through N 320a-320n (collectively, “OTA signal sources 320” or the like), one or more OTA information sources 325 corresponding to the OTA content received from the one or more OTA signal sources 320, and/or one or more other media signals and media information sources 330, and/or the like. In some cases, the one or more other media information sources 330 might include, without limitation, one or more video streaming sources, one or more video broadcast sources, one or more satellite television (“TV”) sources, one or more cable TV sources, one or more third party media information sources, one or more partner provider media information sources, and/or the like. System 300 might further comprise display device 335, which might comprise a display screen 335a.

In addition to receiving media content from the one or more media signal sources 310, the one or more OTA signal sources 320, and/or the other media signal sources 330 for display on the display screen 335a of display device 335, the integrated media presentation device(s) 305 might compile media information from each of the different media information sources 315, 325, and 330. The system (i.e., a set-top box or other computing system, such as STB or media device(s) 105, 205, and/or 280 of FIGS. 1 and 2, or the like) might generate an integrated electronic program guide (“EPG”) 340 that lists, in a blended fashion, information regarding one or more first media content, one or more second video content, and/or one or more third video content, based at least in part on the one or more first media information, the one or more second media information, and/or the one or more third media information from respective media information sources 315, 325, and 330. The system (i.e., a set-top box or other computing system, such as STB or media device(s) 105, 205, and/or 280 of FIGS. 1 and 2, or the like) might display the EPG 340 on the display screen 335a of the display device 335. The EPG 340 might present the blended listing of the information of the one or more first video content, the one or more second video content, and the one or more third video content, in a grid with information regarding at least one of channel 345, media content source 310 or OTA signal source 320 or other media signal source 330, or media content along a first axis of the grid and with start times along a second axis of the grid. Information about the type of media signal source might be listed in dashed line box 350. In FIG. 3, the line 355 (with inward-pointing arrows) indicates the running or current time (which is optionally displayed to the user).

Once the program information and media information have been retrieved, they are processed and checked for inconsistencies to handle cases of potentially conflicting information. In some cases, the consistency mechanism might be needed to recognize and resolve potential inconsistencies among media information from different providers. The processed and formatted programming in formation and media information may be used to populate an integrated EPG, as shown, e.g., in FIG. 3. Programming information can be displayed according to any desired criteria, including, but not limited to, channel numbers, station names, genre, favorites, or a combination of these criteria, and/or the like.

Optionally, the origin of program material may be displayed, as shown in FIG. 3. This feature may be enabled or disabled by the operator and/or by the end user. Examples of origin information or signal source might include, without limitation, “stream” (indicating content streaming to the STB via a network connection), “over the air” or “antenna” (indicating OTA signal received via the antenna), “satellite” (indicating satellite TV signal received via a receiver), “cable” (indicating cable TV signal received by the STB), “3^{rd} party” (indicating content accessed by the STB in other ways), and/or the like. According to some embodiments, users might be able to navigate the EPG 340 in both x and y directions. The x-axis might be used to move forward or backward in time, while the y-axis might be used to move among channels or other content sources. Users can move among channel or other input sources in a seamless way, disregarding the nature of the content source (e.g., network stream, OTA, or the like), and/or the like.

In addition to linear live content, the program guide can include locally stored on-demand content or remotely hosted on-demand content, or both. The EPG data can either be requested from the STB (in a “pull” data distribution model) or offered from the external media information sources (in a “push” data distribution model). The updates and/or refreshes can be triggered based on a number of different events. The trigger might include, without limitation, one of power-up of the media device(s), boot-up of the media device(s), wake-up of the media device(s), periodic update timer, user request operator instruction, or some other event internal or external to the STB, and/or the like.

In some embodiments, OTA devices can contain more than one HDTV tuner or the like. In some cases, very compact devices with as many as four HDTV OTA tuners are readily available. There is no principal reason why the number of tuners cannot be significantly expanded in the future. In some embodiments, the tuner functionality can be expanded to include the ability to receive, demodulate, and decode satellite video signals (“satellite TV signals”). Alternatively, or additionally, the tuner functionality can be expanded to include the ability to receive, demodulate, and decode cable video signals (“cable TV signals”).

According to some embodiments, available content might vary, dependent on the user's location (or location of the customer premises), due to content blackout restrictions, locally available programming and content plan chosen by the subscriber. The integrated media presentation device(s) 305 can take advantage of location information, if available. For example, STBs could be shipped preconfigured with the required location information to properly handle blackout restrictions and local programming. This data could also be derived based on other operator-provided information or information potentially available to the STB (e.g., subscriber phone number or the like). Alternatively, users can enter their address or zip code information or other customer information identifying their location. Advanced systems can also use methods of geolocation such as global positioning system (“GPS”) or comparable system to obtain location information, or the like. The software and/or hardware implementing the system described herein can reside on either the main STB or on the OTA receiver. Alternatively, parts of this integrated EPG, or navigation system could be residing on both the OTA receiver as well as the main STB, and the like.

In some aspects, selection by the user of a streaming channel, an OTA channel, or a third party channel from the displayed integrated EPG 340 might cause the integrated media presentation device(s) 305 to automatically select the input source (regardless of streaming source, OTA signal source, or third party media source, or the like) on the integrated media presentation device(s) 305 for display of the selected channel on the display device 335. For example, in response to receiving a user selection of a particular channel number, a particular named channel, or a particular media content, or the like as displayed on the generated integrated EPG, the media device(s) or integrated media presentation device(s) 305 might automatically tune a signal receiver of the media device(s) or integrated media presentation device(s) 305 to select the input source corresponding to the user selection, might display, on the display device (e.g., display device(s) 335, or the like), video content associated with the selected channel number, named channel, or media content, and might present, on one or more audio playback devices, audio content (or audio signals in video content, or the like) associated with the selected channel number, named channel, or media content, the video content and the audio content being received in the media signals and/or the OTA service signals (and/or the one or more other media signals, or the like).

The integrated media presentation device(s) 305, the display device 335, the one or more media signal sources 310a-310n, the one or more media information sources 315, and the one or more OTA source(s) 320a-320n of system 300 in FIG. 3 might otherwise be similar, if not identical, to the media device(s) 105, the display device 115, the one or more media content sources 135a-135n, the one or more media information sources 155a-155n, and the OTA source(s) 165, respectively, of system 100 in FIG. 1, and the descriptions of these components of system 100 are applicable to the corresponding components of system 300.

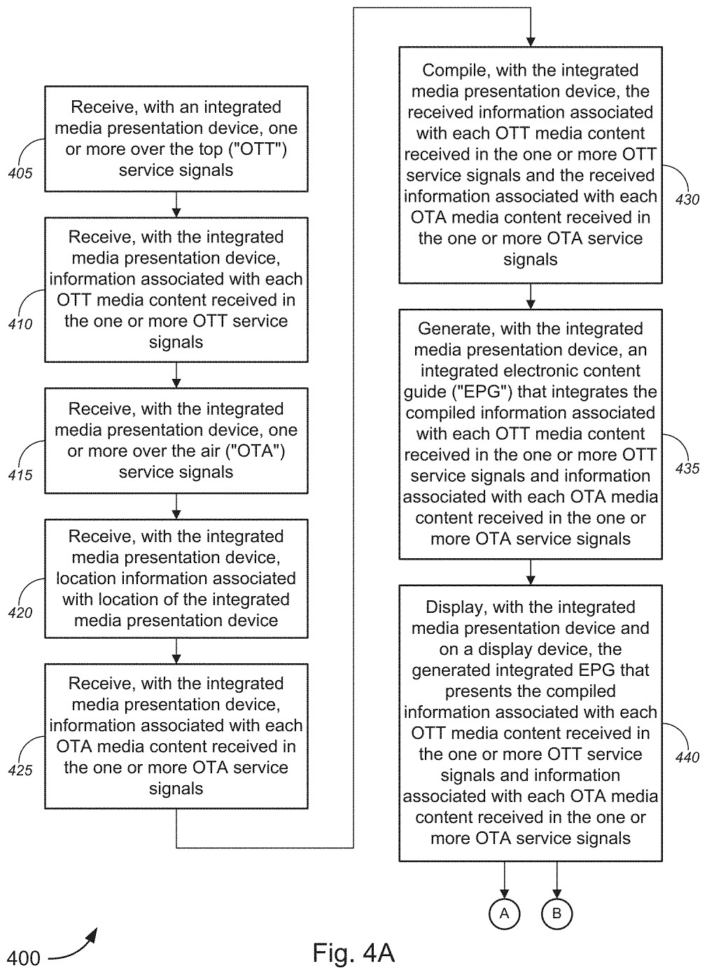

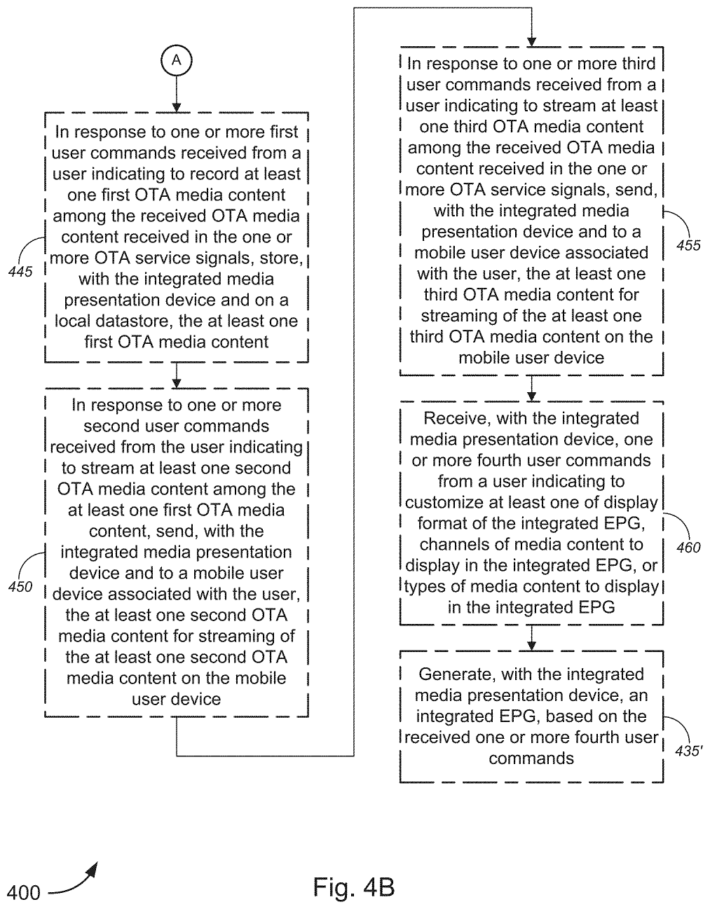

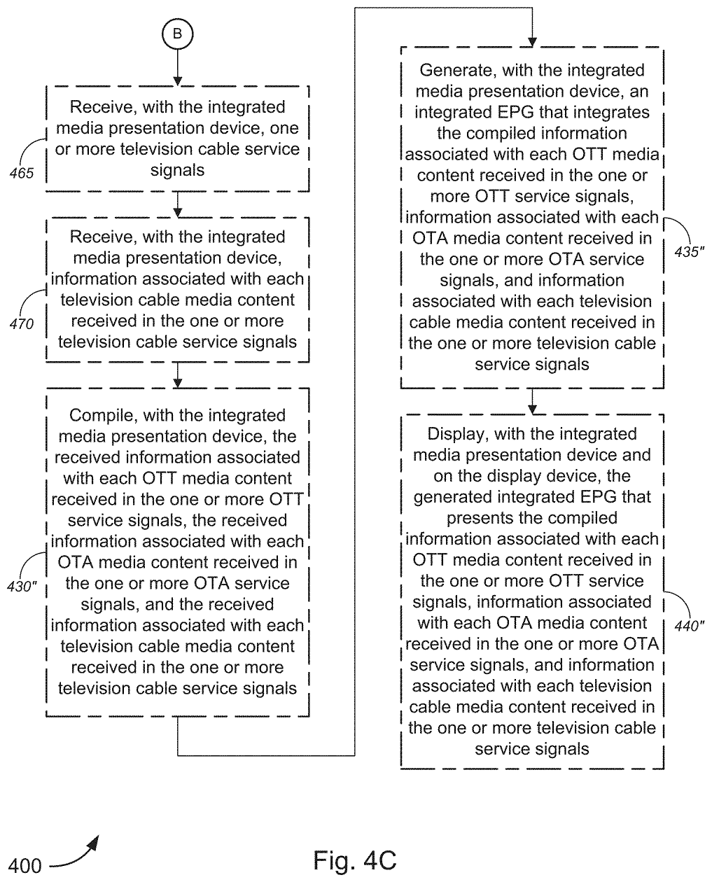

FIGS. 4A-4C (collectively, “FIG. 4”) are flow diagrams illustrating a method 400 for implementing OTT service implementation coupled with OTA tuning, in accordance with various embodiments. Method 400 of FIG. 4A continues onto FIG. 4B following the circular marker denoted, “A,” or continues onto FIG. 4C following the circular marker denoted, “B.”

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 illustrated by FIG. 4 (e.g., by executing instructions embodied on a computer readable medium), the systems, examples, or embodiments 100, 200, and 300 of FIGS. 1, 2, and 3 can each also operate according to other modes of operation and/or perform other suitable procedures.

In the non-limiting embodiment of FIG. 4A, method 400 might comprise receiving, with an integrated media presentation device, one or more over the top (“OTT”) service signals (block 405); receiving, with the integrated media presentation device, information associated with each OTT media content received in the one or more OTT service signals (block 410); receiving, with the integrated media presentation device, one or more over the air (“OTA”) service signals (block 415); receiving, with the integrated media presentation device, location information associated with location of the integrated media presentation device (block 420); and receiving, with the integrated media presentation device, information associated with each OTA media content received in the one or more OTA service signals (block 425), wherein the information associated with each OTA media content received in the one or more OTA service signals might be based on the received location information. At block 430, method 400 might comprise compiling, with the integrated media presentation device, the received information associated with each OTT media content received in the one or more OTT service signals and the received information associated with each OTA media content received in the one or more OTA service signals.

Method 400, at block 435, might comprise generating, with the integrated media presentation device, an integrated electronic program guide (“EPG”) that integrates the compiled information associated with each OTT media content received in the one or more OTT service signals and information associated with each OTA media content received in the one or more OTA service signals. Method 400 might further comprise, at block 440, displaying, with the integrated media presentation device and on a display device, the generated integrated EPG that presents the compiled information associated with each OTT media content received in the one or more OTT service signals and information associated with each OTA media content received in the one or more OTA service signals. Method 400 might continue onto the process at optional block 445 in FIG. 4B following the circular marker denoted, “A,” or might continue onto the process at optional block 465 in FIG. 4C following the circular marker denoted, “B.”

At optional block 445 in FIG. 4B (following the circular marker denoted, “A”), method 400 might comprise, in response to one or more first user commands received from a user indicating to record at least one first OTA media content among the received OTA media content received in the one or more OTA service signals, storing, with the integrated media presentation device and on a local datastore, the at least one first OTA media content, where storing the at least one first OTA media content on the local datastore is performed in a similar manner as storing of OTT media content on the local datastore. At optional block 450, method 400 might comprise, in response to one or more second user commands received from the user indicating to stream at least one second OTA media content among the at least one first OTA media content, sending, with the integrated media presentation device and to a mobile user device associated with the user, the at least one second OTA media content for streaming of the at least one second OTA media content on the mobile user device.

Alternatively, or additionally, method 400, at optional block 455, might comprise, in response to one or more third user commands received from a user (whether the same user as referred to at optional blocks 445 and 450 or a different user) indicating to stream at least one third OTA media content among the received OTA media content received in the one or more OTA service signals, sending, with the integrated media presentation device and to a mobile user device associated with the user, the at least one third OTA media content for streaming of the at least one third OTA media content on the mobile user device.

Alternatively, or additionally, method 400 might further comprise receiving, with the integrated media presentation device, one or more fourth user commands from a user (whether the same user as referred to at optional blocks 445 and 450 or a different user) indicating to customize at least one of display format of the integrated EPG, channels of media content to display in the integrated EPG, or types of media content to display in the integrated EPG, and/or the like (optional block 460). In such cases, generating the integrated EPG (at block 435) might comprise generating, with the integrated media presentation device, an integrated EPG, based on the received one or more fourth user commands (optional block 435′), wherein the display format might include, without limitation, at least one of format, orientation, and order of one or more categories, and/or the like, wherein the one or more categories might include, but is not limited to, at least one of channel numbers, channel designations, or broadcast times, and/or the like.

At optional block 465 in FIG. 4C (following the circular marker denoted, “B” from FIG. 4A), method 400 might comprise receiving, with the integrated media presentation device, one or more television cable service signals. Method 400 might further comprise, at optional block 470, receiving, with the integrated media presentation device, information associated with each television cable media content received in the one or more television cable service signals. In such cases, compiling the received information associated with each OTT media content received in the one or more OTT service signals and the received information associated with each OTA media content received in the one or more OTA service signals (at block 430) might comprise compiling, with the integrated media presentation device, the received information associated with each OTT media content received in the one or more OTT service signals, the received information associated with each OTA media content received in the one or more OTA service signals, and the received information associated with each television cable media content received in the one or more television cable service signals (optional block 430″). Generating the integrated electronic program guide (“EPG”) that integrates the compiled information associated with each OTT media content received in the one or more OTT service signals and information associated with each OTA media content received in the one or more OTA service signals (at block 435) might comprise generating, with the integrated media presentation device, an integrated EPG that integrates the compiled information associated with each OTT media content received in the one or more OTT service signals, information associated with each OTA media content received in the one or more OTA service signals, and information associated with each television cable media content received in the one or more television cable service signals (optional block 435″). Displaying the generated integrated EPG that presents the compiled information associated with each OTT media content received in the one or more OTT service signals and information associated with each OTA media content received in the one or more OTA service signals (at block 440) might comprise displaying, with the integrated media presentation device and on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals (optional block 440″).

### Exemplary System and Hardware Implementation

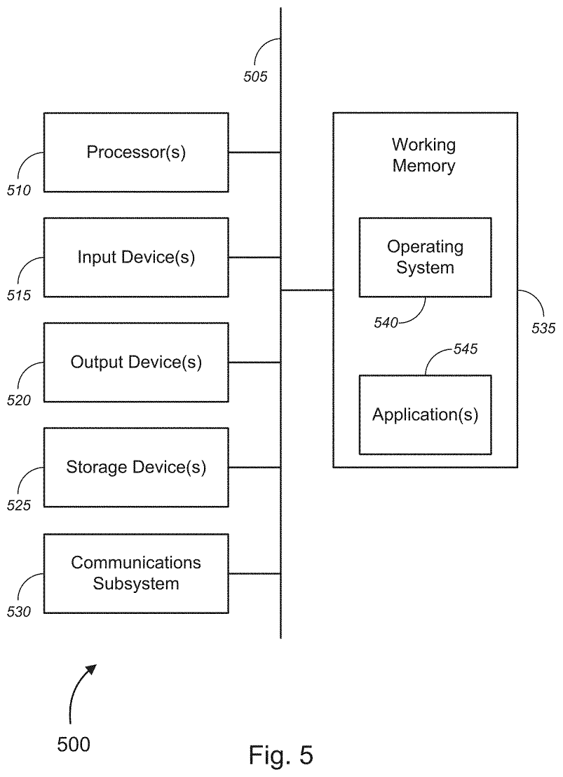

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., media devices 105, 205, 280, and 305, display devices 115, 215, and 335, user device(s) 120, audio playback devices 125a-125n and 285, media content or signal sources (or servers) 135a-135n, 235a-235n, and 310a-310n, media information sources (or servers) 155a-155n, 255a-255n, 315, and 330, and over the air (“OTA”) sources 165, 265, and 320a-320n, OTA information sources (or servers) 325, and residential gateway device 270, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., media devices 105, 205, 280, and 305, display devices 115, 215, and 335, user device(s) 120, audio playback devices 125a-125n and 285, media content or signal sources (or servers) 135a-135n, 235a-235n, and 310a-310n, media information sources (or servers) 155a-155n, 255a-255n, 315, and 330, and OTA sources 165, 265, and 320a-320n, OTA information sources (or servers) 325, and residential gateway device 270, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

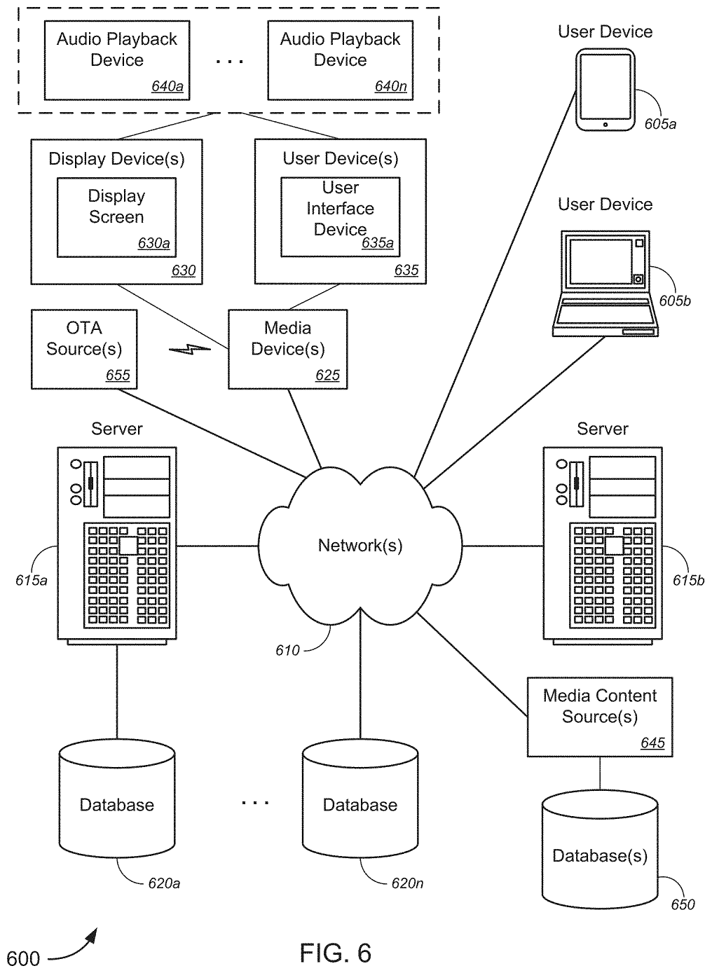

As noted above, a set of embodiments comprises methods and systems for implementing presentation of media content, and, more particularly, to methods, systems, and apparatuses for implementing over the top (“OTT”) service implementation coupled with over the air (“OTA”) tuning. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to network(s) 145 FIG. 1 and network(s) 245 FIG. 2, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing presentation of media content, and, more particularly, to methods, systems, and apparatuses for implementing over the top (“OTT”) service implementation coupled with over the air (“OTA”) tuning, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise one or more media devices 625 (similar to media devices 105, 205, 280, and 305 of FIGS. 1-3, or the like), one or more display devices 630 each with display screen 630a (similar to display devices 115, 215, and 335 of FIGS. 1-3, or the like), one or more user devices 635 each with user interface device 635a (similar to user device(s) 120 of FIG. 1, or the like), one or more audio playback devices 640a-640n (similar to audio playback devices 125a-125n and 285 of FIGS. 1 and 2, or the like), one or more media (e.g., video) content sources 645 and corresponding database(s) 650 (similar to media or video content sources (or servers) 135a-135n, 235a-235n, and 310a-310n and corresponding databases 140a-140n and 240a-240n of FIGS. 1-3, or the like), and over the air (“OTA”) source(s) 655 (similar to OTA sources 165, 265, and 320a-320n of FIGS. 1-3, or the like).

In operation, the media device(s) 625 might receive one or more over the top (“OTT”) service signals (e.g., from media content source(s) 645, or the like); might receive information associated with each OTT media content received in the one or more OTT service signals; might receive one or more OTA service signals (e.g., from OTA source(s) 655, or the like); might receive location information associated with location of the integrated media presentation device; and receive information associated with each OTA media content received in the one or more OTA service signals, where the information associated with each OTA media content received in the one or more OTA service signals might be based on the received location information. The media device(s) 625 might compile the received information associated with each OTT media content received in the one or more OTT service signals and the received information associated with each OTA media content received in the one or more OTA service signals; might generate an integrated electronic program guide (“EPG”) that integrates the compiled information associated with each OTT media content received in the one or more OTT service signals and information associated with each OTA media content received in the one or more OTA service signals; and might display, on a display device (e.g., display device(s) 630 or the like), the generated integrated EPG that presents the compiled information associated with each OTT media content received in the one or more OTT service signals and information associated with each OTA media content received in the one or more OTA service signals.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with an integrated media presentation device, one or more over the top (“OTT”) service signals;
receiving, with the integrated media presentation device, information associated with each OTT media content received in the one or more OTT service signals;
receiving, with the integrated media presentation device, one or more over the air (“OTA”) service signals;
receiving, with the integrated media presentation device, location information associated with location of the integrated media presentation device;
receiving, with the integrated media presentation device, information associated with each OTA media content received in the one or more OTA service signals, wherein the information associated with each OTA media content received in the one or more OTA service signals is based on the received location information;
compiling, with the integrated media presentation device, the received information associated with each OTT media content received in the one or more OTT service signals and the received information associated with each OTA media content received in the one or more OTA service signals;
generating, with the integrated media presentation device, an integrated electronic program guide (“EPG”) that integrates the compiled information associated with each OTT media content received in the one or more OTT service signals and information associated with each OTA media content received in the one or more OTA service signals; and
displaying, with the integrated media presentation device and on a display device, the generated integrated EPG that presents the compiled information associated with each OTT media content received in the one or more OTT service signals and information associated with each OTA media content received in the one or more OTA service signals.

2. The method of claim 1, wherein the integrated media presentation device comprises at least one of a set-top box (“STB”), a digital video recording and playback device (“DVR”), a universal serial bus (“USB”)-based streaming device, a cable television tuner, an OTT tuner, or an OTA tuner.

3. The method of claim 1, wherein the integrated media presentation device comprises a master device and one or more slave devices that service two or more display devices in a customer premises associated with a user.

4. The method of claim 3, wherein the master device comprises an OTA tuner, while the one or more slave devices do not comprise any OTA tuners.

5. The method of claim 1, wherein the location information associated with the location of the integrated media presentation device comprises at least one of local area code, local zip code, billing address of a user associated with the integrated media presentation device, service address of the user associated with the integrated media presentation device, or location data obtained for identifying location of the integrated media presentation device.

6. The method of claim 1, further comprising:
in response to one or more first user commands received from a user indicating to record at least one first OTA media content among the received OTA media content received in the one or more OTA service signals, storing, with the integrated media presentation device and on a local datastore, the at least one first OTA media content, wherein storing the at least one first OTA media content on the local datastore is performed in a similar manner as storing of OTT media content on the local datastore.

7. The method of claim 6, further comprising:
in response to one or more second user commands received from the user indicating to stream at least one second OTA media content among the at least one first OTA media content, sending, with the integrated media presentation device and to a mobile user device associated with the user, the at least one second OTA media content for streaming of the at least one second OTA media content on the mobile user device.

8. The method of claim 1, further comprising:
in response to one or more third user commands received from a user indicating to stream at least one third OTA media content among the received OTA media content received in the one or more OTA service signals, sending, with the integrated media presentation device and to a mobile user device associated with the user, the at least one third OTA media content for streaming of the at least one third OTA media content on the mobile user device.

9. The method of claim 1, further comprising:
receiving, with the integrated media presentation device, one or more television cable service signals; and
receiving, with the integrated media presentation device, information associated with each television cable media content received in the one or more television cable service signals;
wherein compiling the received information associated with each OTT media content received in the one or more OTT service signals and the received information associated with each OTA media content received in the one or more OTA service signals comprises compiling, with the integrated media presentation device, the received information associated with each OTT media content received in the one or more OTT service signals, the received information associated with each OTA media content received in the one or more OTA service signals, and the received information associated with each television cable media content received in the one or more television cable service signals;
wherein generating the integrated EPG that integrates the compiled information associated with each OTT media content received in the one or more OTT service signals and information associated with each OTA media content received in the one or more OTA service signals comprises generating, with the integrated media presentation device, an integrated EPG that integrates the compiled information associated with each OTT media content received in the one or more OTT service signals, information associated with each OTA media content received in the one or more OTA service signals, and information associated with each television cable media content received in the one or more television cable service signals; and
wherein displaying the generated integrated EPG that presents the compiled information associated with each OTT media content received in the one or more OTT service signals and information associated with each OTA media content received in the one or more OTA service signals comprises displaying, with the integrated media presentation device and on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals.

10. The method of claim 1, further comprising:
receiving, with the integrated media presentation device, one or more fourth user commands from a user indicating to customize at least one of display format of the integrated EPG, channels of media content to display in the integrated EPG, or types of media content to display in the integrated EPG;
wherein generating the integrated EPG comprises generating, with the integrated media presentation device, an integrated EPG, based on the received one or more fourth user commands, wherein the display format comprises at least one of format, orientation, or order of one or more categories, wherein the one or more categories comprises at least one of channel numbers, channel designations, or broadcast times.

11. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive one or more over the top (“OTT”) service signals;
receive information associated with each OTT media content received in the one or more OTT service signals;
receive one or more over the air (“OTA”) service signals;
receive location information associated with location of the integrated media presentation device;
receive information associated with each OTA media content received in the one or more OTA service signals, wherein the information associated with each OTA media content received in the one or more OTA service signals is based on the received location information;
compile the received information associated with each OTT media content received in the one or more OTT service signals and the received information associated with each OTA media content received in the one or more OTA service signals;
generate an integrated electronic program guide (“EPG”) that integrates the compiled information associated with each OTT media content received in the one or more OTT service signals and information associated with each OTA media content received in the one or more OTA service signals; and
display, on a display device, the generated integrated EPG that presents the compiled information associated with each OTT media content received in the one or more OTT service signals and information associated with each OTA media content received in the one or more OTA service signals.

12. The apparatus of claim 11, wherein the apparatus comprises at least one of a set-top box (“STB”), a digital video recording and playback device (“DVR”), a universal serial bus (“USB”)-based streaming device, a cable television tuner, an OTT tuner, or an OTA tuner.

13. The apparatus of claim 11, wherein the apparatus comprises a master device and one or more slave devices that service two or more display devices in a customer premises associated with a user.

14. The apparatus of claim 13, wherein the master device comprises an OTA tuner, while the one or more slave devices do not comprise any OTA tuners.

15. The apparatus of claim 11, wherein the set of instructions, when executed by the at least one processor, further causes the apparatus to:
in response to one or more first user commands received from a user indicating to record at least one first OTA media content among the received OTA media content received in the one or more OTA service signals, storing, with the apparatus and on a local datastore, the at least one first OTA media content, wherein storing the at least one first OTA media content on the local datastore is performed in a similar manner as storing of OTT media content on the local datastore.

16. The apparatus of claim 15, wherein the set of instructions, when executed by the at least one processor, further causes the apparatus to:
in response to one or more second user commands received from the user indicating to stream at least one second OTA media content among the at least one first OTA media content, sending, with the apparatus and to a mobile user device associated with the user, the at least one second OTA media content for streaming of the at least one second OTA media content on the mobile user device.

17. The apparatus of claim 11, wherein the set of instructions, when executed by the at least one processor, further causes the apparatus to:
in response to one or more third user commands received from a user indicating to stream at least one third OTA media content among the received OTA media content received in the one or more OTA service signals, sending, with the apparatus and to a mobile user device associated with the user, the at least one third OTA media content for streaming of the at least one third OTA media content on the mobile user device.

18. The apparatus of claim 11, wherein the set of instructions, when executed by the at least one processor, further causes the apparatus to:
receive one or more television cable service signals; and
receive information associated with each television cable media content received in the one or more television cable service signals;
wherein compiling the received information associated with each OTT media content received in the one or more OTT service signals and the received information associated with each OTA media content received in the one or more OTA service signals comprises compiling the received information associated with each OTT media content received in the one or more OTT service signals, the received information associated with each OTA media content received in the one or more OTA service signals, and the received information associated with each television cable media content received in the one or more television cable service signals;
wherein generating the integrated EPG that integrates the compiled information associated with each OTT media content received in the one or more OTT service signals and information associated with each OTA media content received in the one or more OTA service signals comprises generating an integrated EPG that integrates the compiled information associated with each OTT media content received in the one or more OTT service signals, information associated with each OTA media content received in the one or more OTA service signals, and information associated with each television cable media content received in the one or more television cable service signals; and
wherein displaying the generated integrated EPG that presents the compiled information associated with each OTT media content received in the one or more OTT service signals and information associated with each OTA media content received in the one or more OTA service signals comprises displaying, on the display device, the generated integrated EPG that presents the compiled information associated with each OTT media content received in the one or more OTT service signals, information associated with each OTA media content received in the one or more OTA service signals, and information associated with each television cable media content received in the one or more television cable service signals.

19. The apparatus of claim 11, wherein the set of instructions, when executed by the at least one processor, further causes the apparatus to:
receive one or more fourth user commands from a user indicating to customize at least one of display format of the integrated EPG, channels of media content to display in the integrated EPG, or types of media content to display in the integrated EPG;
wherein generating the integrated EPG comprises generating an integrated EPG, based on the received one or more fourth user commands, wherein the display format comprises at least one of format, orientation, or order of one or more categories, wherein the one or more categories comprises at least one of channel numbers, channel designations, or broadcast times.

20. A system, comprising:
an integrated media presentation device, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the integrated media presentation device to:
receive one or more over the top (“OTT”) service signals;
receive information associated with each OTT media content received in the one or more OTT service signals;
receive one or more over the air (“OTA”) service signals;
receive location information associated with location of the integrated media presentation device;
receive information associated with each OTA media content received in the one or more OTA service signals, wherein the information associated with each OTA media content received in the one or more OTA service signals is based on the received location information;
compile the received information associated with each OTT media content received in the one or more OTT service signals and the received information associated with each OTA media content received in the one or more OTA service signals;
generate an integrated electronic program guide (“EPG”) that integrates the compiled information associated with each OTT media content received in the one or more OTT service signals and information associated with each OTA media content received in the one or more OTA service signals; and
display, on a display device, the generated integrated EPG that presents the compiled information associated with each OTT media content received in the one or more OTT service signals and information associated with each OTA media content received in the one or more OTA service signals.
